(19) United States
(12) Patent Application Publication
(10) Pub. No.: US 2015/0012201 A1
(43) Pub. Date: Jan. 8, 2015

(54) BRAKE CONTROL SYSTEM COMPRISING RUNWAY FRICTION PROPERTY ESTIMATION MAPPING

(71) Applicant: GOODRICH CORPORATION, CHARLOTTE, NC (US)

(72) Inventors: RICHARD PAUL METZGER, TROY, OH (US); RICHARD KOLK, TROY, OH (US)

(21) Appl. No.: 13/935,137

(22) Filed: Jul. 3, 2013

(51) Int. Cl. B64C 25/42

(52) U.S. Cl. CPC B64C 25/42
USPC 701/82

(57) ABSTRACT

Systems and methods for detecting the onset of wheel skids and controlling brake torque to achieve efficient and smooth braking performance are described herein. A brake control system may utilize an algorithm, along with substantially real-time measured values to assist with controlling brake torque to achieve efficient and smooth braking performance. A history of wheel speed information, such as wheel speed information associated with one or more landing event, may also be used to iteratively estimate tire/runway friction properties.

### FIELD

The present disclosure relates to brake control systems, and more particularly, to detecting an on ground condition related to aircraft and/or aircraft brake control systems.

### BACKGROUND

Aircraft landing gear is typically equipped with brakes in order to stop an aircraft after landing. Aircraft wheels often comprise a wheel base, a side rim, and a lock ring. In some cases, in systems haying large wheel bases (e.g., 19 inches (48.26 centimeters) in diameter or greater), high torque at application speed may lead to a wheel-skid. A wheel-skid is an event in which the tire and side rim continue to roll at ground speed, while the wheel base is locked to the brake and not rotating. A wheel-skid is in contrast to a tire-skid, where the tire is stationary, and sliding, relative to the runway. Historically, prior to landing, having prior knowledge of various runway conditions was not possible.

### SUMMARY

Systems and methods for determining an on ground characteristic related to an aircraft landing are disclosed. In various embodiments, the system may include a method for determining a coefficient of friction associated with a portion of a runway. This method may comprise measuring a first gear reference speed for a first landing gear of an aircraft. This method may comprise measuring, the first gear instantaneous speed for the first landing gear of the aircraft. Additional measurements may be made on any of the landing gear components. This method may comprise determining a slip ratio of the first landing gear. This method may comprise estimating a weight of an aircraft associated with the first landing gear. This method may comprise mapping position data to the measured values. This method may comprise determining/estimating the coefficient of friction associated with various locations along the portion of the runway.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates, in accordance with various embodiments, a front view of an aircraft on a runway;

FIG. 2 illustrates, in accordance with various embodiments, a top view of an aircraft on a runway;

FIG. 3 illustrates, in accordance with various embodiments, a block diagram of a brake control system;

FIG. 4 illustrates, in accordance with various embodiments, a graph depicting coefficient of friction vs. slip ratio curve; and

FIG. 5 illustrates, in accordance with various embodiments, a method for determining various coefficients of friction and/or the slip ratio as a function of position.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the disclosure, it should be understood that other embodiments may be realized and that logical, chemical, and mechanical changes may he made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

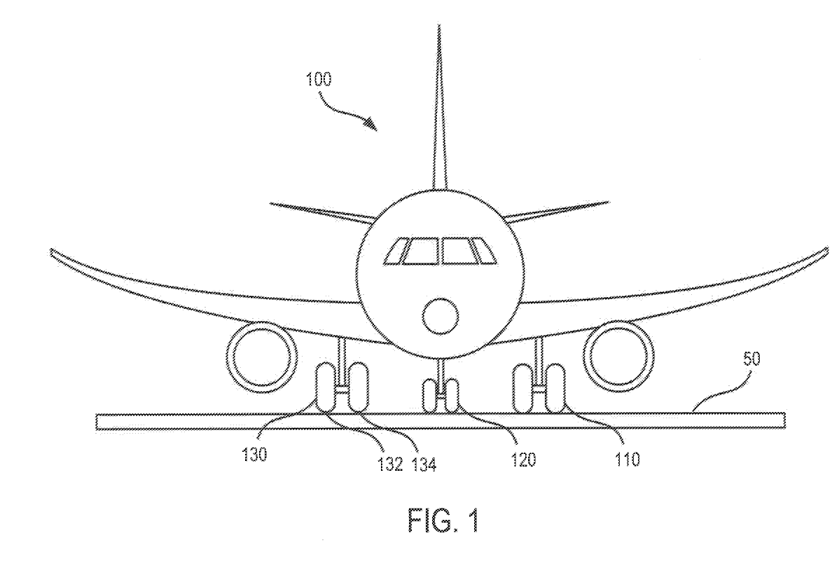

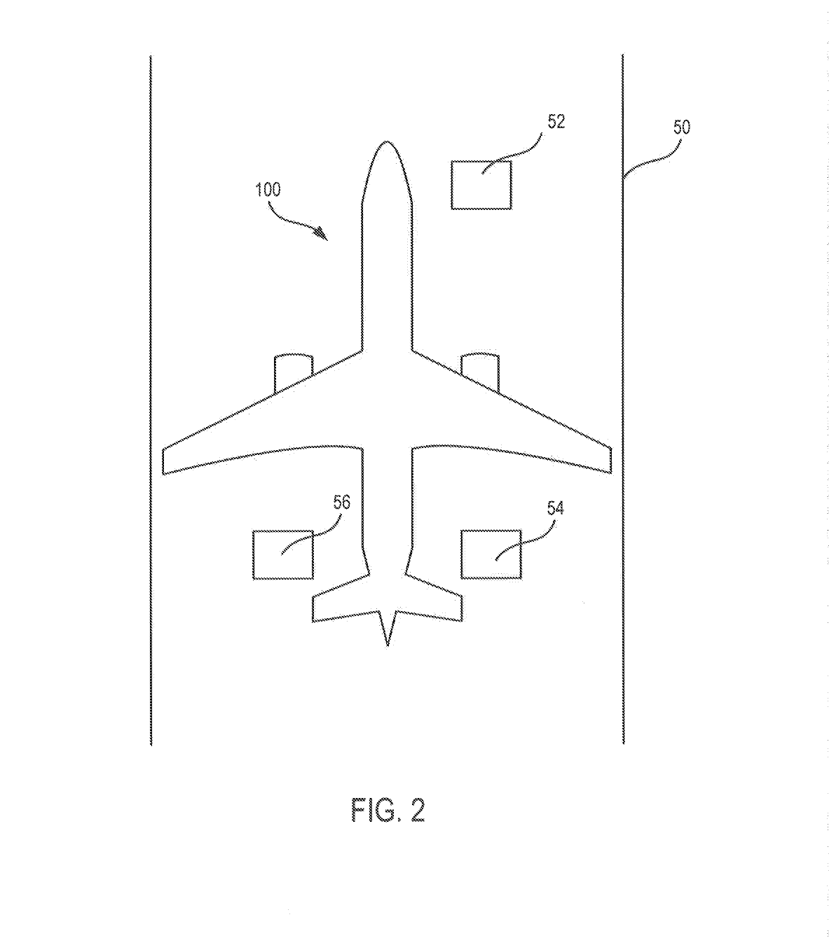

According to various embodiments, a map and/or a portion of a map may be produced based on substantially real-time information regarding the runway characteristics for use during a landing event. This information may include slip ratio and co-efficient of friction information according to position, such as according to various positions along runway 50 at various times (see FIGS. 1 and 2).

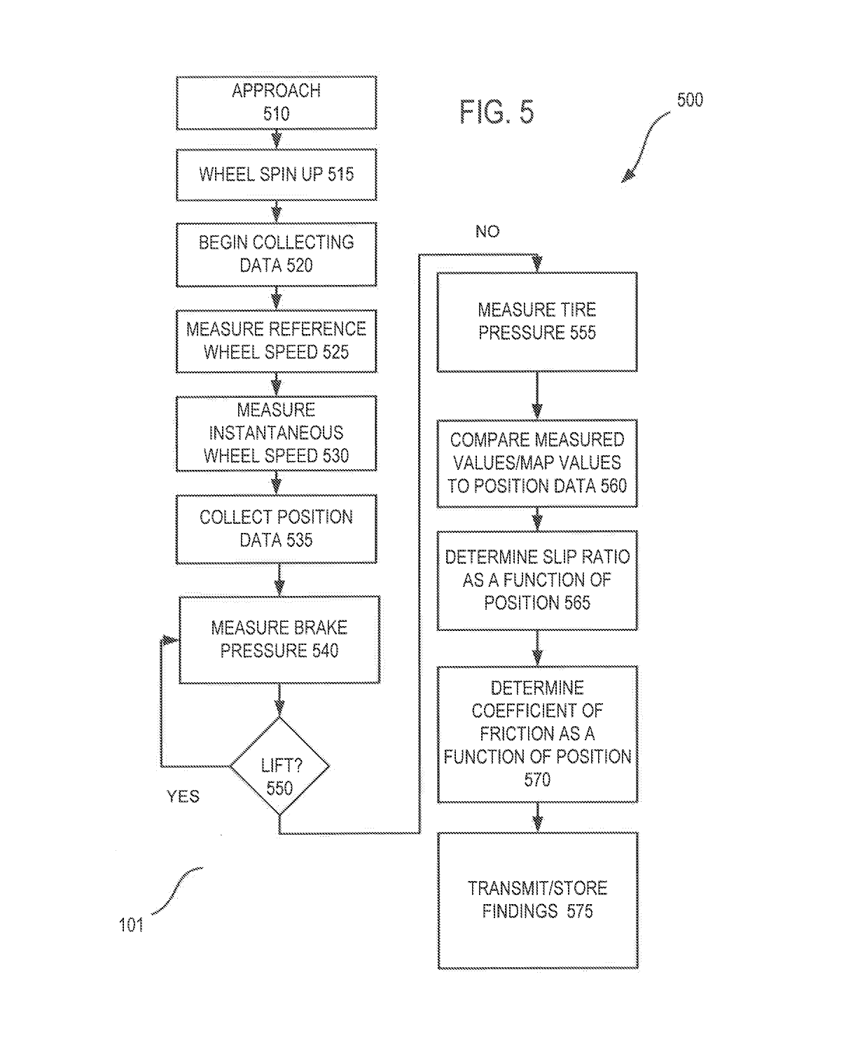

According to various embodiments, a brake control system 101 (described in greater detail in FIG. 5) may be configured to continuously assess tire/runway 50 friction properties, detect the onset of wheel skids, and control brake torque to achieve efficient and smooth braking performance. Thus, brake control system 101 may utilize an algorithm, along with substantially real-time measured values to assist with controlling brake torque to achieve efficient and smooth braking performance. A history of wheel speed information, such as wheel speed information associated with one or more landing event, may also be used to iteratively estimate tire/runway 50 friction properties.

Referring to FIG. 1, a front view of an aircraft 100 on runway 50 is illustrated according to various embodiments. Aircraft 100 may comprise landing gear including left main landing gear (“LMLG”) 110, nose landing gear (“NLG”) 120, and right main landing gear (“RMLG”) 130. Each gear may comprise two wheels. For example, RMLG 130 comprises right outboard wheel 132 and right inboard wheel 134. However, in various embodiments, aircraft 100 may comprise any number of gears and each gear may comprise any number of wheels.

Referring to FIG. 2, a top view of aircraft 100 on runway 50 is illustrated according to various embodiments. Thus, in various embodiments, one or more aircraft 100 wheels may be in contact with the pavement of runway 50. Different coefficients of friction of runway 50 at various positions, such as positions 52, 54, and 56, may cause the wheels of aircraft 100 to spin up at varying rates. In various embodiments, the wheels associated with LMLG 110 may spin up faster than the wheels associated with RMLG 130 due to a higher coefficient of friction for runway 50 at one position versus another position. In various embodiments, runway 50 may comprise multiple contaminants, such as ice, mud, oil, fuel, water and/or snow, each of which may affect a measured/estimated coefficient of friction at various positions. The measured/estimated coefficient of friction at various positions along runway 50 may be time-specific. For instance, the measured/estimated coefficient of friction at various locations may change based on conditions over time.

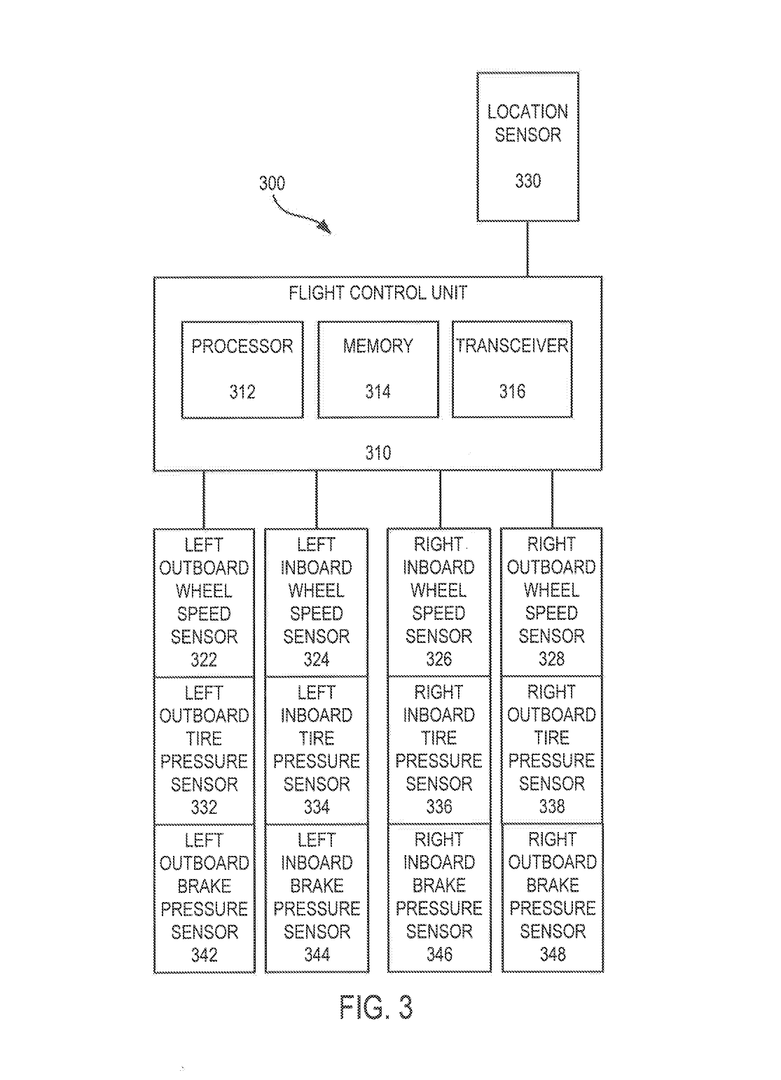

Referring to FIG. 3, a system 300 for detecting on ground characteristics is illustrated according to various embodiments. System 300 may comprise a flight control unit 310. Brake control system 101 may be a subsystem of flight control unit 310. Brake control system 101 may be in communication with flight control unit 310. Brake control system 101 may be communicatively coupled to left outboard wheel speed sensor 322, left inboard wheel speed sensor 324, right inboard wheel speed sensor 326 and right outboard wheel speed sensor 328. Brake control system 101 may comprise a left outboard tire pressure sensor 332, left inboard tire pressure sensor 334, right inboard tire pressure sensor 336, and right outboard tire pressure sensor 338. Tire pressure measurements may be used to infer a weight and force present on the tires at various times/locations. Brake control system 101 may comprise a left outboard brake pressure sensor 342, left inboard brake pressure sensor 344, right inboard brake pressure sensor 346, and right outboard brake pressure sensor 348.

A location sensor 330 may be coupled to brake control system 101 and/or flight control unit 310. Location sensor 330 may be a GPS unit/receiver. Location sensor 330 may be configured to determine position of aircraft 100 at each braked wheel location. Flight control unit 310 may be coupled to a transceiver 316. The various components may be electronically coupled. In various embodiments, the various components may communicate via wireless and/or wired communications, For example, wheel speed sensors 322, 324, 326, 328 may wirelessly transmit wheel speed measurements to brake control system 101 and in turn to flight control unit 310.

Flight control unit 310 and/or brake control system 101 may comprise a computing device (e.g., processor 312) and an associated memory 314. Memory 314 may comprise an article of manufacture including a tangible, non-transitory computer-readable storage medium having instructions stored thereon that, in response to execution by a computing device (e.g., processor 312), cause the computing device to perform various methods.

Wheel speed sensors 322, 324, 326, 328 may measure a wheel speed. Wheel speed sensors 322, 324, 326, 328 may comprise any device capable of measuring a wheel speed. For example, in various embodiments, wheel speed sensors 322, 324, 326, 328 may comprise electromagnetic transducers and/or fiber optic transducers, in various embodiments, the wheel speed sensors may comprise an AC sensor which uses a magnet surrounded by a pickup coil in an axle of the landing gear. In various embodiments, wheel speed sensors 322, 324, 326, 328 may comprise a DC sensor which may comprise a permanent magnet direct current generator, which outputs a voltage proportional to a rotational speed of its armature. Additionally, wheel speed sensors 322, 324, 326, 328 may detect a change in a rate of deceleration of the wheels and signal for braking pressure to be decreased in order to assist in anti skid braking.

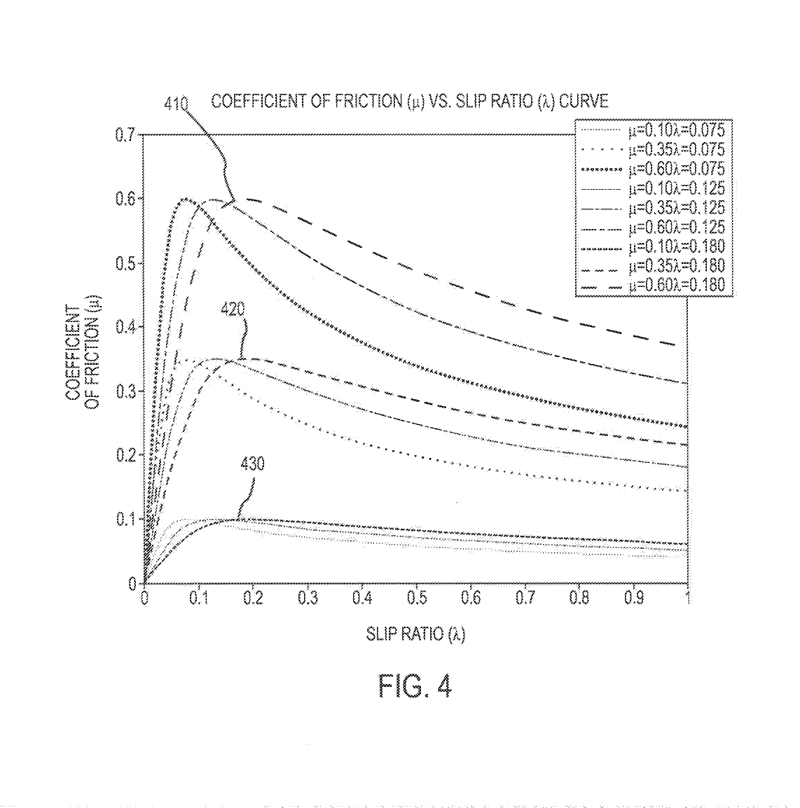

The wheel speed may be the actual measured speed of the wheel. In various embodiments, each wheel on aircraft 100 may be equipped with a wheel speed sensor 322, 324, 326, 328. However, in various embodiments, aircraft 100 may comprise one wheel speed sensor per gear, or may comprise wheel speed sensors on the main landing gears. Wheel speed sensors 322, 324, 326, 328 may transmit the wheel speed data to flight control unit 310. Flight control unit 310 may calculate a reference wheel speed for each wheel. The reference wheel speed may be the over ground speed that the wheel would be travelling if the wheel were rolling without slipping. For example, if wheel speed sensor 322, 324, 326, 328 measures a wheel speed of 10 radians per second for a wheel with a radius of 2 meters, flight control unit 310 may calculate a reference wheel speed of 20 meters per second. During spin up and subsequent braking, wheels may be at least partially slipping. Thus, the wheel reference speed may be less than the actual speed of aircraft 100 during spin up and braking events. Processor 312 may map the measured wheel speed measurements to aircraft 100 position data on un way 50 to determine an estimate of the coefficient of friction for portions of runway 50 and/or the slip ratio of the wheel as a function of position, A wheel slip may occur in response to the force applied to a tire exceeding the traction available to that tire. Processor 312 may utilize a measured brake pressure mapped to aircraft 100 position data on the runway 50 to determine an estimate of the coefficient of friction and/or the slip ratio as a function of position. In response to landings that involve the anti-skid function, peak wheel accelerations may be used to estimate wheel slip values (see FIG. 4). In response to landings that do not involve the anti-skid function, wheel speed and accelerations may be used to estimate a lower bound of the wheel slip value. A landing that does not involve the anti-skid function may be a landing where the wheel does not lock in position in response to the beaks being applied.

For instance, in response to a wheel speed dropout event (about 10 kts, about 18.52 Km/hr), (when lift is no longer affecting a weight calculation) an estimate of aircraft 100 weight is obtained and the instantaneous runway 50 friction property may be calculated for each of the braked wheels as a function of aircraft 100 position data (previously recorded, such as by location sensor 330). Estimating the weight of the aircraft may involve determining a tire pressure of a tire of the first landing gear and calculating the weight of the aircraft based on the determined change tire pressure from a known reference value. This calculation may be done “after-the-fact” as an accurate aircraft 100 weight measurement cannot generally be obtained during the landing due to transient lift. For instance, at certain speeds, lift from the wings may substantially affect a weight measurement. Thus, this after-the-fact calculation may be made in response to aircraft 100 traveling at a speed where there is no lift adversely affecting the calculation.

Runway 50 touchdown and/or a wheel speed dropout location data may be obtained from a position/location sensor 330, such as a GPS unit/receiver. The positioning data may be used in conjunction with a measured number of wheel rotations for each wheel. The wheel rotation count and the wheel radius may be used to estimate the absolute runway 50 positions; which, in turn, have associated slip and friction values (which may be calculated/extrapolated from the measured wheel speeds and, brake pressure, and/or tire pressures at those locations).

This information may be transmitted to a system external to aircraft 100 and made available for additional aircraft landing on runway 50. The findings of the actual location, e.g. portions of runway 50 traveled by aircraft 100, during a landing event, at various intervals may be aggregated with measured results of other aircraft having brake control system 101 to develop an expanded knowledge of runway 50 and its characteristics for a period of time. Brake control system 101 may create a moving average of the data to identify longer-term trends of the coefficient of friction and/or the slip ratio as a function of position. This expanded knowledge of runway 50 characteristics may be communicated to additional components of aircraft 100 and/or other aircraft in the vicinity or expected to be in the vicinity so that appropriate action may be taken.

In operation, in response to a touchdown associated with a landing on runway 50, wheel speed information is collected. Initially, each wheel is subject to a spin off condition, to bring the wheels up from substantially stationary to a rolling speed which is the same as aircraft 100 during landing. During this period, a touchdown protection phase is enacted so that no brakes are applied. In response to a wheel speed spin up and/or touchdown, a wheel reference value measurement is made. A wheel reference value may be an estimate of aircraft 100 speed measured at each wheel. Thus, aircraft 100 equivalent speed which is the instantaneous wheel speed and wheel reference data may be initial quantities for brake control system 101. Initially these values should be substantially equivalent. In response to applying a brake, a drag force is generated. In turn, these values (e.g. the instantaneous wheel speed and the wheel reference value) separate. The brake pressure from sensors 342, 344, 346, 348 and/or the tire pressure from sensors 332, 334, 336, 338 may be measured at this time. Based on the friction generated, the rotation of each wheel relative to aircraft 100 speed is decreased. Thus, the estimated aircraft 100 speed (e.g. wheel reference value) vs. instantaneous wheel speed may be plotted.

Referring to FIG. 4, a graph depicting a coefficient of friction vs. the slip ratio as a function of position according to various embodiments is presented. The separation between wheel reference values and the instantaneous wheel speed data and/or the ratio of the wheel reference values and the instantaneous wheel speed values may be used to develop this data. This data plotted at various times and/or positions may yield information regarding conditions of the runway and capacities of the braking system associated with those conditions. Varied runway conditions will affect the data. For instance, dry runway conditions may be associated with peak 410. Wet runway conditions may be associated with peak 420. Icy runway conditions may be associated with peak 430.

In response to brake pressure increasing, the torque generated may be estimated. A measured acceleration maximum during a period where aircraft 100 is generating wheel slips corresponds to the coefficient of friction versus slip ratio relationship. Thus, in response to maximum accelerations being measured, an estimate of the slip ratio curve and the value of coefficient of friction associated with the slip ratio may be gleaned.

in response to an anti-skid system initiating, (skidding of the wheel) the wheel reference value speed will decrease. In response to this reduction in speed, a peak of a new slip curve will be crossed. Each peak, 410, 420, 430 corresponds to a peak acceleration. In a landing where an anti-skid system is enacted multiple times, the threshold will be crossed multiple times and establish a new peaks at various plotted locations.

The peak of the new slip curve may be a peak friction point given the slip ratio. In response to a braking stop where there is no skidding, (e.g. no anti-skid system event), a lower bound to a slip ratio may be established. This lower hound established the wheel is at least capable of this much friction without a slip event. This information may be exploited by aircraft 100.

Referring to FIG. 5, a process 500 for detecting an on ground characteristic is illustrated according to various embodiments. As aircraft 100 prepares for landing, flight control unit 310 may be in approach mode (Step 510). In response to aircraft 100 landing the wheels rotations may be spun up to aircraft 100 speed (Step 515). Brake control system 101 may begin collecting data in response to the landing (Step 520). The reference wheel speed and instantaneous speed may be measured at intervals (Step 525, 530). Wheel speed sensor readings may be made by the sensors, 322, 324, 326, 328 of brake control system 101 and communicated to flight control unit 310. Location information, such as location information at any brake location, may be gathered via location sensor 330 at any time (Step 535). Location information may be measured by brake control system 101 sensors, such as location sensor 330, and communicated to flight control unit 310. As brakes, are applied, brake pressure may be measured by brake pressure sensors, 342, 344, 346, 348 of brake control system 101 and communicated to flight control unit 310 (Step 540). A determination of wheel speed may be used to determine if aircraft 100 is experiencing lift. In response to aircraft 100 traveling at a speed where lift from the wings would not affect a weight calculation, a tire pressure reading may be made (Step 555). Tire pressure readings may be made by the sensors, 332, 334, 336, 338 of brake control system 101 and communicated to flight control unit 310. This may be at one or more wheels. A weight of aircraft 100 estimation may be made by flight control unit 310 via the tire pressure readings and prior knowledge of the aircraft weight.

The reference wheel speed and the instantaneous wheel speed will begin to separate as the brakes are applied and friction is produced. These values may be compared by processor 312 utilizing one or more algorithms to determine a slip ratio as a function of position (Step 560, 565). Acceleration maximums of the wheels may be noted as part of this process 500. A coefficient of friction may be determined/estimated as a function of position. These measured/estimated coefficient of friction values may be mapped to relevant portions of runway 50 (Step 570). Measured values and/or determinations may be stored to memory 314 and/or transmitted by transceiver 316 (Step 575).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein, In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The term “coefficient of friction” as used herein may refer to the ratio of the three that maintains contact between an object and a surface and the frictional force that resists the motion of the object. The frictional force may be equal to the coefficient of friction multiplied by the normal force on the surface. Slip ratio as used here may refer to a means of calculating and expressing the locking status of a wheel, Slip Ratio %=[(Vehicle Speed−Wheel Speed)/Vehicle Speed]×100.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for determining coefficients of friction along a portion of a runway comprising:
measuring, by a flight control processor, a first gear reference speed for a first landing gear of an aircraft;
measuring, by the flight control processor, a first gear instantaneous speed for the first landing gear of the aircraft;
determining, by the flight control processor, a slip ratio of the first landing gear;
estimating, by the flight control processor, a weight of the aircraft associated with the first landing gear;
mapping, by the flight control processor, position data to the measured values; and
estimating, by the flight control processor, coefficients of friction associated with locations along the portion of the runway.

2. The method of claim 1, wherein the calculating the first gear reference speed comprises measuring a wheel speed of a wheel on the first landing gear.

3. The method of claim 1, wherein the estimating the weight of the aircraft comprises determining a tire pressure of a tire of the first landing gear, and calculating the weight of the aircraft based on the determined change tire pressure from a known reference value.

4. The method of claim 1, further comprising transmitting the first gear reference speed from a wheel speed sensor to the flight control processor.

5. The method of claim 1, further comprising calculating position data from a location sensor.

6. The method of claim 5, wherein the location sensor is a global positioning unit.

7. The method of claim 1, wherein the calculating the first gear reference speed comprises averaging a wheel reference speed of a plurality of wheels on the first landing gear.

8. The method of claim 1, further comprising determining that lift on wings of the aircraft is not affecting the weight of the aircraft determination.

9. The method of claim 1, further comprising transmitting the determined coefficient of friction associated with the portion of the runway to a central processor.

10. The method of claim 1, further comprising aggregating determined coefficient of friction information from additional aircraft to establish an expanded mapping of the coefficient of friction associated with the runway.

11. The method of claim 1, wherein the portion of the runway is associated with a path of travel of the aircraft.

12. The method of claim 1, wherein a lower bound of wheel slip values may be calculated in response to a braking stop comprising no anti-skid system event.

13. The method of claim 1, wherein an anti-skid system event associated with the aircraft is used to plot peak wheel accelerations.

14. The method of claim 13, wherein peak wheel accelerations are used to estimate wheel slip values.

15. The method of claim 1, wherein the determined coefficient of friction associated with the portion of the runway are exploited to detect an onset of a wheel skid.

16. The method of claim 1, wherein the determined coefficients of friction associated with the portion of the runway are exploited to achieve smooth braking performance.

17. An article of manufacture including a non-transitory, tangible computer readable medium having instructions stored thereon that, in response to execution by a computing device, cause the computer-based system to perform operations comprising:
measuring, by the computing device, a first gear reference speed for a first landing gear of an aircraft;
measuring, by the computing device, a first gear instantaneous speed for the first landing gear of the aircraft;
determining, by the computing device, a slip ratio of the first landing gear;
estimating, by the computing device, a weight of the aircraft associated with the first landing gear;
mapping, by the computing device, position data to the measured values; and
estimating, by the computing device, coefficients of friction associated with locations along a portion of a runway.

18. The article of manufacture of claim 17, further comprising transmitting, by the computing device, the determined coefficient of friction associated with the portion of the runway to a central processor.

19. The article of manufacture of claim 17, further comprising calculating position data from a location sensor.

20. A system comprising:
a tangible, non-transitory memory communicating with a processor,
the tangible, non-transitory memory having instructions stored thereon that, in response to execution by the processor, cause the processor to perform operations comprising:
measuring, by the processor, a first gear reference speed for a first landing gear of an aircraft;
measuring, by the processor, a first gear instantaneous speed for the first landing gear of the aircraft;
determining, by the processor, a slip ratio of the first landing gear;
estimating, by the processor, a weight of the aircraft associated with the first landing gear;
mapping, by the processor, position data to the measured values; and
estimating, by the processor, coefficients of friction associated with locations along a portion of a runway.
